(19) United States
(12) Patent Application Publication
(10) Pub. No.: US 2012/0291716 A1
(43) Pub. Date: Nov. 22, 2012

(54) APPARATUS FOR SHEDDING ANTLERS

(76) Inventors: Donald David Cook, Mobile, AL (US); Kevin F. Masterson, Montrose, AL (US)

(21) Appl. No.: 13/109,552

(22) Filed: May 17, 2011

(51) Int. Cl. A01K 13/00

(52) U.S. Cl. 119/600

(57) ABSTRACT

An apparatus for shedding antlers is disclosed. The apparatus includes a rod, wherein the rod includes a threaded end that is exposed. A mold substantially surrounds the rod and includes protrusions. The apparatus further includes a mount having a hole. The hole allows the threaded and exposed end of the rod to be inserted therein. The mount is coupled to a deer feeder or tree. The apparatus is constructed to exert sufficient force to shed the antlers when the antlers come into proximity with the apparatus.

### FIELD OF THE INVENTION

This invention relates to an apparatus for shedding antlers. More specifically, this invention relates to an apparatus for shedding antlers that includes a rod, a mold substantially surrounding the rod, and a mount coupled to an object, such as a deer feeder or tree, wherein an end of the rod is inserted in a hole of the mount.

### BACKGROUND OF THE INVENTION

Deer hunting is an activity or sport of pursuing and harvesting deer, dating back to tens of thousands of years ago. While deer hunting remains a popular pastime, the collecting of shed antlers, such as those shed by deer, elk and other antlered species, has become a serious hobby. Shed antlers, once collected, are put to myriad uses. They are used as decorative elements in furnishings, architecture and other products. Hunters often use shed antlers to “rattle in” game during hunting season.

To collect shed antlers, many hunters and other outdoorsmen attach and configure a wire mesh to a deer feeder. The goal is to entangle the deer's antlers in the wire when they are ready to come off. A typical design currently used by most people interested in collecting sheds is shown in FIG. 1. Deer feeder 100 comprises a large feed storage container 110, feed ports 130, 131, and 132, and feeder legs 120, 121, and 122. (Sometimes, such feeders are suspended from trees.) A single wire strand 160 is running about 3 feet off the ground from each feeder leg 120, 121, and 122. As shown in the FIG. 1, a first deer 150 is feeding from the feed port 130, while a second deer 155 is reaching down to feed on the ground underneath the feed storage container 110 where feed often falls from the feeder ports 130, 131, and 132.

The theory is that when deer 155 raises his head his antlers would get entangled in the wire 160 and, if they were loose and ready to come off, the antlers would pull free and hang in the wire 160 (or fall to the ground near the wire). However, this is a crude concept for collecting sheds. It requires the deer (or other animals) to knock down the feed and reach down to eat the feed off the ground. If there is no feed on the ground the deer will have no reason to reach down and then raise his antlers, causing the antlers to get entangled in the wire. Plus, the antlers have to be ready to come off for the shed antler collection apparatus of FIG. 1 to be effective. Otherwise, the deer can be trapped in the wire, resulting in an animal that is badly harmed.

### SUMMARY OF THE INVENTION

The present invention is directed to an apparatus for shedding antlers. In one embodiment of the present invention, the apparatus comprises a rod, wherein the rod includes a threaded end that is exposed. The apparatus also includes a mold substantially surrounding the rod, wherein the mold includes protrusions. The apparatus further includes a mount having a hole, the hole allowing the threaded and exposed end of the rod to be inserted therein, wherein the mount is coupled to a deer feeder. The apparatus also includes a nut and a washer to attach the threaded and exposed end to the mount. The apparatus is constructed to exert sufficient force to shed the antlers when the antlers come into proximity with the apparatus. More specifically, the apparatus creates friction with the antlers when the antlers enter and then withdraw from the apparatus, thus dislodging the horns.

The mold is made from, but not limited to, one of the following: rubber, plastic, a polymer blend, and carbon fiber. In one embodiment, the protrusions resemble tree limbs and leaves. In other embodiments, the protrusions resemble either a natural outdoor environment or a camouflage pattern.

In one embodiment, the rod is made of metal. The metal is made of, but not limited to, steel. In other embodiments, the rod is made of either carbon fiber or plastic.

In another embodiment of the present invention, an apparatus for shedding antlers is disclosed. The apparatus comprises a plurality of rods, wherein each rod includes a threaded end that is exposed. The apparatus also includes a mold substantially surrounding each of the plurality of rods, wherein the mold includes protrusions. The apparatus further includes a mount having a plurality of holes. Each hole allows the threaded and exposed end of each of the plurality of rods to be inserted therein. Further, the mount is coupled to a deer feeder.

In another embodiment of the present invention, an apparatus for shedding antlers is disclosed. The apparatus comprises a plurality of steel rods, wherein each steel rod includes a threaded end that is exposed. The apparatus also includes a rubber mold substantially surrounding each of the plurality of steel rods, wherein the mold includes protrusions resembling tree limbs and leaves. The apparatus further includes a mount having a plurality of holes. Each hole allows the threaded and exposed end of each of the plurality of rods to be inserted therein. The mount is coupled to a tree.

In another embodiment, the mold, rods, and mount can be made of any material. Further, the protrusions can be of any shape or design capable of entangling antlers.

### BRIEF DESCRIPTION OF THE DRAWINGS

FIG. 1 shows a prior art apparatus for shedding antlers.

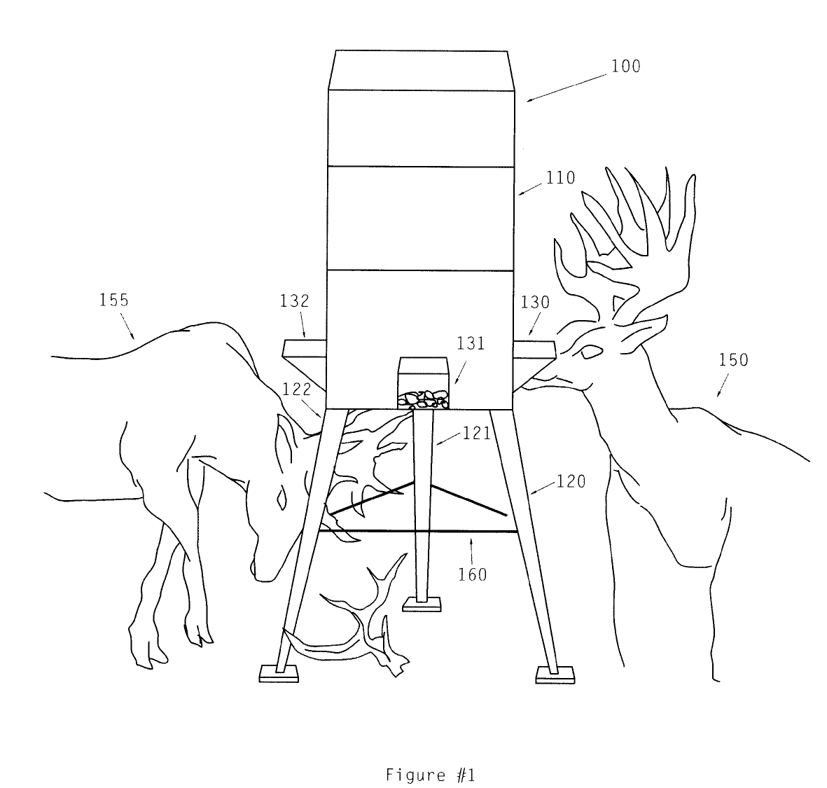

FIG. 2 shows an apparatus for shedding antlers, in accordance with one embodiment of the present.

FIG. 3 shows an apparatus for shedding antlers, in accordance with one embodiment of the present invention.

FIG. 4 shows an apparatus for shedding antlers, in accordance with one embodiment of the present invention.

FIG. 5 shows a mold on a rod, the mold including protrusions that resemble tree limbs and leaves, in accordance with one embodiment of the present invention.

FIG. 6 shows a one-piece apparatus including multiple rods, a molding substantially surrounding each rod and including protrusions, a steel plate structure and steel bolts, in accordance with one embodiment of the present invention.

FIG. 7 shows an apparatus for shedding antlers in use, installed in proximity to a deer feeder, in accordance with one embodiment of the present invention.

FIG. 8 shows an apparatus for shedding antlers, in accordance with one embodiment of the present invention.

FIG. 9 shows an apparatus for shedding antlers coupled to an adapter via a bracket, for use with a deer feeder having a down spout, in accordance with an alternative embodiment of the present invention.

### DETAILED DESCRIPTION OF THE PREFERRED EMBODIMENTS

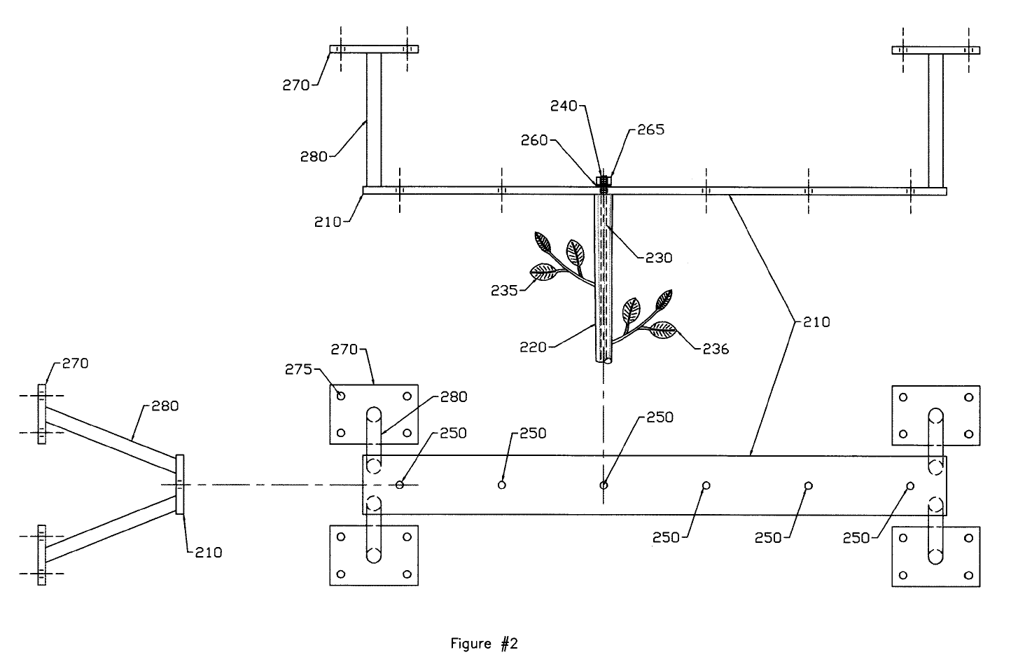

FIG. 2 shows an apparatus for shedding antlers, in accordance with one embodiment of the present. The apparatus includes a mount 210 having at least one hole 250. The apparatus also includes a rod 230 substantially surrounded by a mold 220. The mold 220 includes protrusions 235 and 236. The protrusions 235 and 236 resemble tree limbs and leaves. The rod 230 includes a threaded end 240 that is exposed. The hole 250 allows the threaded and exposed end 240 of the rod 230 to be inserted in the hole 250. The apparatus also includes a nut 265 and a washer 260 to attach the threaded and exposed end 240 to the mount 210.

The mount 210 can be coupled to a deer feeder (not shown) via a support frame 270 and bolts 275 or screws. The mount 210 is coupled to the support frame 270 via an extension rod 280. Alternatively, the mount 210 can be coupled to a tree (not shown) or any object in close proximity to a feeding area for deer. The apparatus is constructed to exert sufficient force to shed antlers when the antlers come into proximity with the apparatus.

The mold 220 is made from, but not limited to, one of the following: rubber, plastic, a polymer blend, and carbon fiber.

The rod 230 is made from, but not limited to, one of the following: metal, carbon fiber, and plastic. The metal can be made from steel.

In another embodiment, the mold, rods, and mount can be made of any material.

Further, the protrusions can be of any shape or design capable of entangling antlers.

In an alternative embodiment, the protrusions 235 and 236 resemble either a natural outdoor environment or a camouflage pattern.

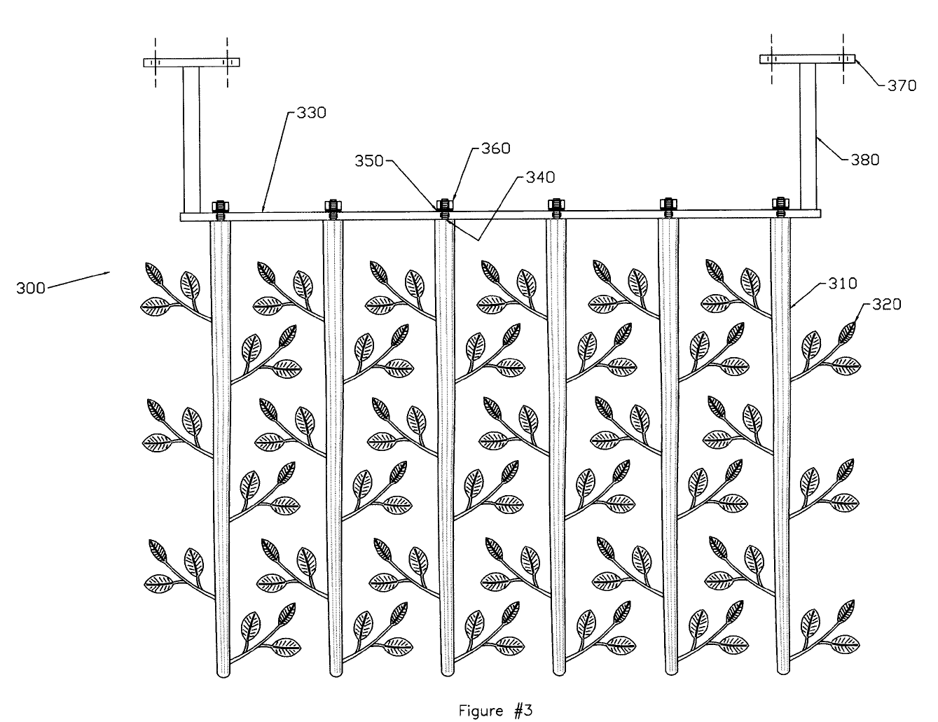

FIG. 3 shows an apparatus 300 for shedding antlers, in accordance with one embodiment of the present invention. The apparatus 300 includes a plurality of rods 310 substantially surrounded by a mold. The mold includes protrusions 320. The apparatus 300 includes a mount 330 having a plurality of holes 340. Each hole 340 allows a threaded and exposed end of each of the plurality of rods 310 to be inserted in each hole 340. The apparatus 300 includes a nut 360 and a washer 350 to attach the threaded and exposed end of the rods 310 to the mount 330. The mount 330 can be coupled to an object, such as a deer feeder or tree, via a support frame 370. The support frame 370 can includes bolts or screws. The mount 330 is coupled to the support frame 370 via an extension rod 380.

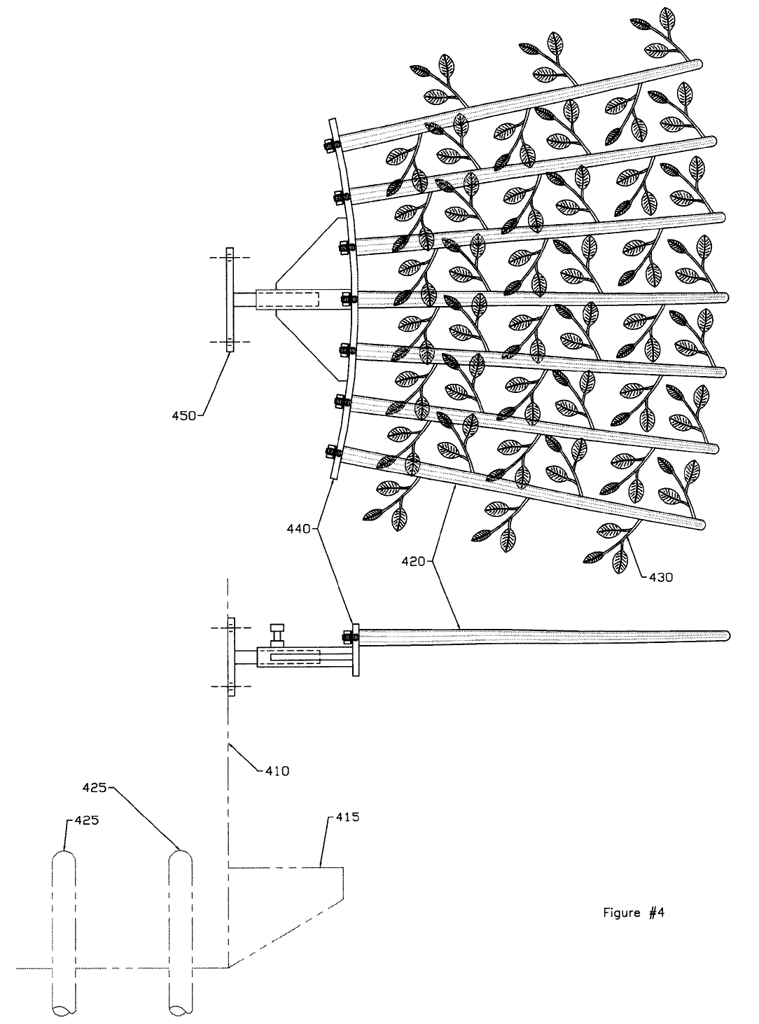

FIG. 4 shows an apparatus for shedding antlers, in accordance with one embodiment of the present invention. In the FIG. 4, a deer feeder 410 having a feed port 415 and a plurality of legs 425 is shown. A mount 440 is coupled to the deer feeder 410 via a support frame 450. The mount 440 includes holes (not shown) which allow a threaded and exposed end of one or more rods 420 to be inserted in the holes. A mold substantially surrounds the one or more rods 420, and includes protrusions 430 resembling either tree limbs and leaves, a natural outdoor environment, a camouflage pattern, or any other shape or design.

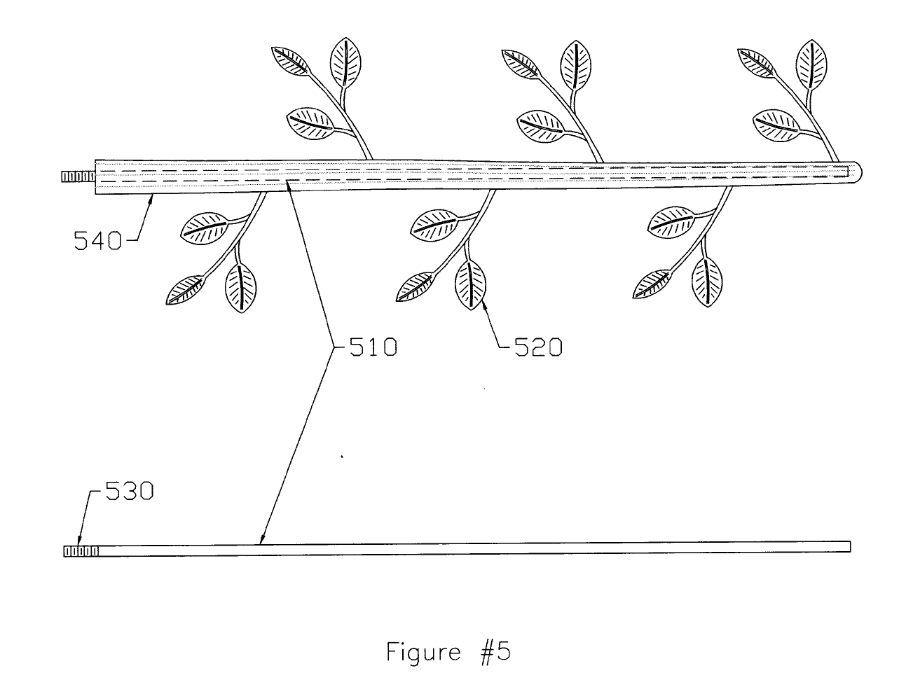

FIG. 5 shows a mold 540 on a rod 510, the mold including protrusions 520 that resemble tree limbs and leaves, in accordance with one embodiment of the present invention. The rod 510 has a threaded end 530 that is exposed.

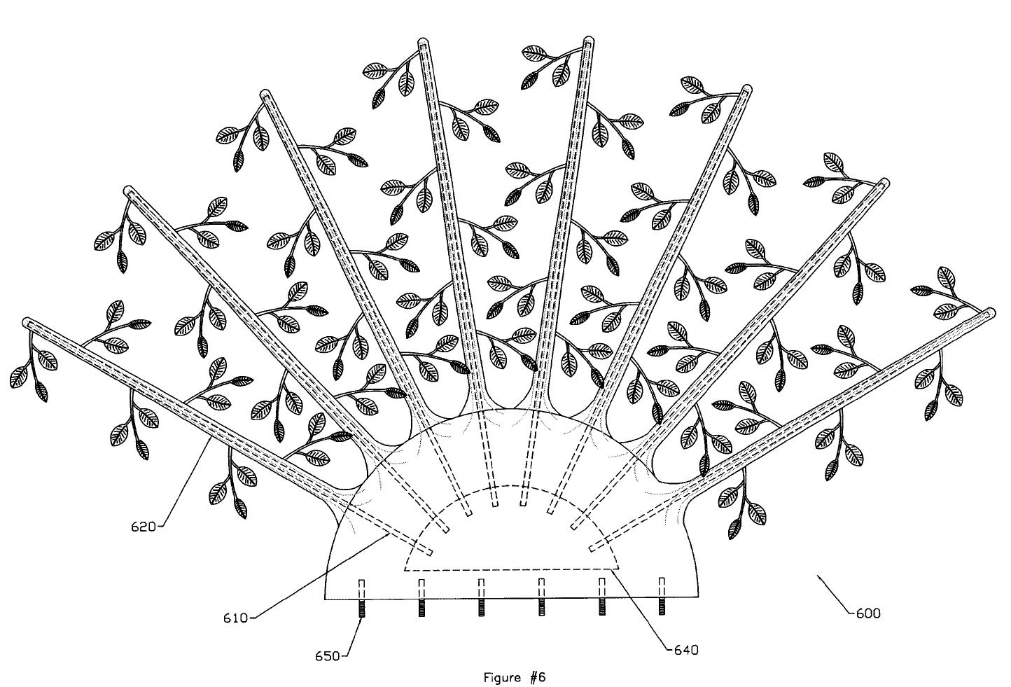

FIG. 6 shows a one-piece apparatus 600 including multiple rods 610, a molding 620 substantially surrounding each rod 610 and including protrusions 630, a plate structure 640 and bolts 650, in accordance with one embodiment of the present invention. In one embodiment, the plate structure 640 and bolts 650 are made of steel. The one-piece apparatus 600 is injection molded as a solid unit.

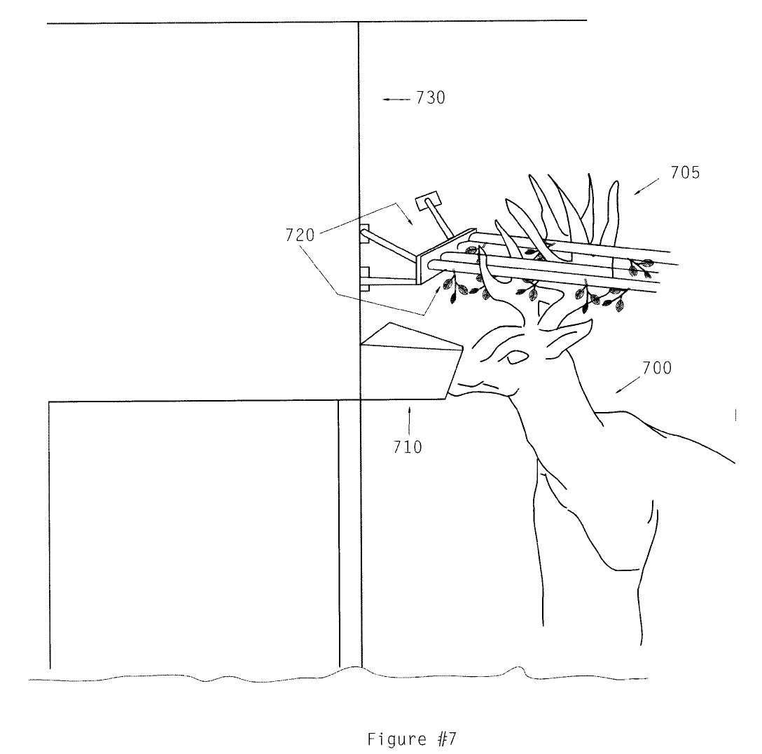

FIG. 7 shows an apparatus 720 for shedding antlers in use, installed in proximity to a deer feeder 730, in accordance with one embodiment of the present invention. The deer feeder 730 includes a feed port 710 where a deer 700 having antlers 705 is feeding. As shown in the FIG. 7, the deer's antlers are entangled in the apparatus 720 while the deer 700 is feeding. The apparatus 720 creates friction, dislodging the antlers 705 as the deer withdraws from the apparatus 720. More specifically, the antlers 705 get entangled with the protrusions of the apparatus 720, knocking the antlers off, when the deer is withdrawing from the apparatus 720.

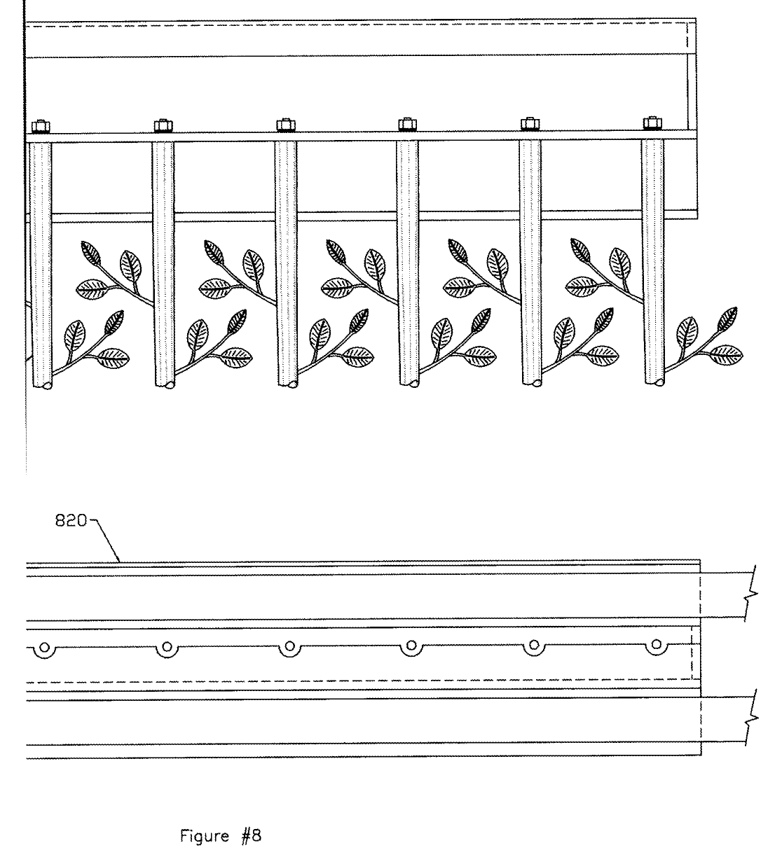

FIG. 8 shows an apparatus for shedding antlers, in accordance with one embodiment of the present invention. The apparatus includes a mount 820 having a plurality of holes. A plurality of rods 830 is shown, wherein each rod 830 is substantially surrounded by a mold. The mold includes protrusions 840. A threaded and exposed end of each rod 830 is inserted in each hole of the mount 820.

Still referring to FIG. 8, the apparatus is mounted to an object, such as a deer feeder or tree, using two ratchet straps 810 and 815. The straps 810 and 815 are threaded through a slot of the mount 820. The straps 810 and 815 provide a secure fit to many different types of feeders and different sized trees.

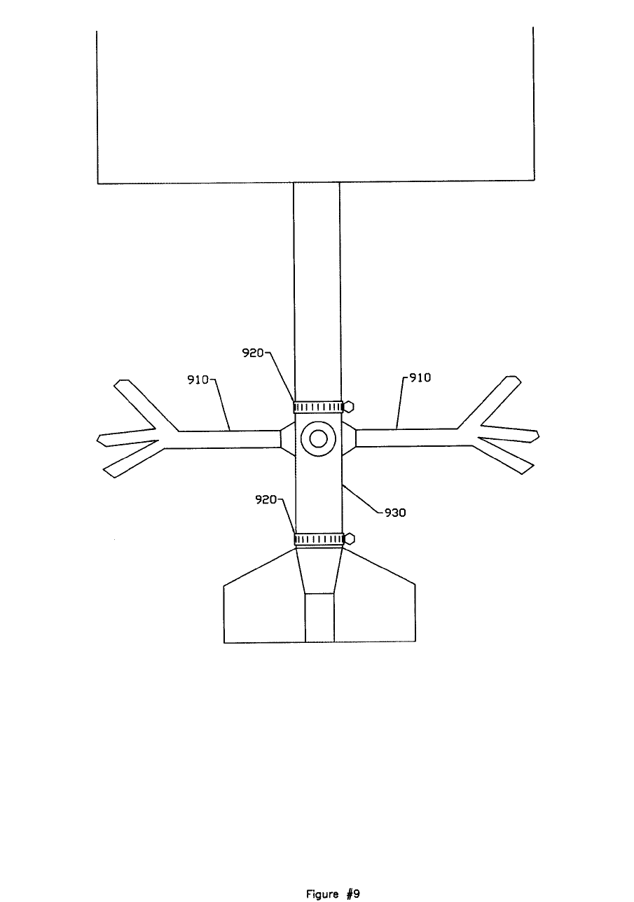

FIG. 9 shows an apparatus 910 for shedding antlers coupled to an adapter 930 via a bracket 920, for use with a deer feeder having a down spout, in accordance with an alternative embodiment of the present invention. In one embodiment, the adapter 930 can be a plastic coupling coupled to the deer feeder. The bracket 920 can be a clamp, such as a C-clamp, or any device for holding together two pieces.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention

What is claimed is:

1. An apparatus for shedding antlers comprising:
a. a rod, wherein the rod includes a threaded end that is exposed;
b. a mold substantially surrounding the rod, wherein the mold includes protrusions; and
c. a mount having a hole, the hole allowing the threaded and exposed end of the rod to be inserted therein, wherein the mount is coupled to a deer feeder.

2. The apparatus of claim 1 further comprising a nut and a washer to attach the threaded and exposed end of the rod to the mount.

3. The apparatus of claim 1 wherein the mold is made from one of the following: rubber, plastic, a polymer blend, and carbon fiber.

4. The apparatus of claim 1 wherein the protrusions resemble tree limbs and leaves.

5. The apparatus of claim 1 wherein the protrusions resemble one of a natural outdoor environment and a camouflage pattern.

6. The apparatus of claim 1 wherein the apparatus is constructed to exert sufficient force to shed the antlers when the antlers come into proximity with the apparatus.

7. The apparatus of claim 1 wherein the rod is made of metal.

8. The apparatus of claim 7 wherein the metal is steel.

9. The apparatus of claim 1 wherein the rod is made from one of the following: carbon fiber and plastic.

10. An apparatus for shedding antlers comprising:
a. a plurality of rods, wherein each rod includes a threaded end that is exposed;
b. a mold substantially surrounding each of the plurality of rods, wherein the mold includes protrusions; and
c. a mount having a plurality of holes, each hole allowing the threaded and exposed end of each of the plurality of rods to be inserted therein, wherein the mount is coupled to a deer feeder.

11. The apparatus of claim 10 further comprising a plurality of nuts and washers to attach the threaded and exposed end of each rod to the mount.

12. The apparatus of claim 10 wherein the mold is made from one of the following:
rubber, plastic, a polymer blend, and carbon fiber.

13. The apparatus of claim 10 wherein the protrusions resemble tree limbs and leaves.

14. The apparatus of claim 10 wherein the protrusions resemble one of a natural outdoor environment and a camouflage pattern.

15. The apparatus of claim 10 wherein the apparatus is constructed to exert sufficient force to shed the antlers when the antlers come into proximity with the apparatus.

16. The apparatus of claim 10 wherein the rods are made of metal.

17. The apparatus of claim 16 wherein the metal is steel.

18. The apparatus of claim 10 wherein the rods are made of one of the following: carbon fiber and plastic.

19. An apparatus for shedding antlers comprising:
a. a plurality of steel rods, wherein each steel rod includes a threaded end that is exposed;
b. a rubber mold substantially surrounding each of the plurality of steel rods, wherein the mold includes protrusions resembling tree limbs and leaves; and
c. a mount having a plurality of holes, each hole allowing the threaded and exposed end of each of the plurality of rods to be inserted therein.

20. The apparatus of claim 19 wherein the mount is coupled to a tree.
